(19) United States
(12) Patent Application Publication
(10) Pub. No.: US 2024/0399361 A1
(43) Pub. Date: Dec. 5, 2024

(54) POCT MICROFLUIDIC CHIP AND DETECTION SYSTEM

(71) Applicant: HEFEI NUOMAIJI BIOTECH CO., LTD, Anhui (CN)

(72) Inventor: Yuchao LIU, Anhui (CN)

(73) Assignee: HEFEI NUOMAIJI BIOTECH CO., LTD, Anhui (CN)

(21) Appl. No.: 18/701,255

(22) PCT Filed: Jun. 15, 2022
(86) PCT No.: PCT/CN2022/098876

§ 371 Date: Apr. 15, 2024

(30) Foreign Application Priority Data
May 7, 2022 (CN) 202210493174.0

(51) Int. Cl. B01L 3/00; B01L 7/00

(52) U.S. Cl. CPC B01L 3/5027; B01L 7/52; B01L 2200/10; B01L 2300/0819; B01L 2300/0861

(57) ABSTRACT

The invention discloses a POCT microfluidic chip and a detection system. The POCT microfluidic chip comprises an upper casing and a lower casing, and also comprises a sample pool, a mixed liquid pool, a waste liquid pool and a reaction pool. The reaction pool is connected to the mixed liquid pool through a microchannel, wherein the reaction pool comprises at least two constant temperature chambers, wherein a bottom of each constant temperature chamber is embedded with a superconducting thermal body and each constant temperature chamber has a different temperature, wherein the constant temperature chambers communicate with each other through microchannels, wherein each constant temperature chamber is equipped with an airbag pool, which communicates with a corresponding constant temperature chamber through a microchannel.

### TECHNICAL FIELD

The invention belongs to the technical field of POCT detection using molecular diagnostic technology, and particularly to a POCT microfluidic chip, a POCT detection system comprising the POCT microfluidic chip, and a molecular diagnostic technology POCT detection method based on the POCT microfluidic chip. The invention also relates to the application of the POCT microfluidic chip.

### TECHNICAL BACKGROUND

POCT (point-of-care testing) refers to a testing method that is performed at the sampling site and uses portable analytical instruments and supporting reagents to quickly obtain test results. The meaning of POCT can be understood from two aspects: spatially, the test is performed next to the patient, that is, “bedside test”; temporally, it can be “point-of-care testing”. The main criteria of POCT are that it does not require a fixed testing location, the reagents and instruments are portable, and can be operated in a timely manner. It has the advantages of speed, simplicity of use, and overall cost savings.

At present, polymerase chain reaction (PCR), as an emerging technology, has suddenly emerged and become the main mode in the field of molecular diagnosis. At present, various large-scale multi-functional PCR detection equipment can be seen everywhere, making outstanding contributions to the global fight against the epidemic. However, as a powerful detection method, how to realize convenient detection and enter thousands of households is a challenge to contemporary scientific researchers. As a technology for accurately controlling and manipulating micro-scale fluids, microfluidic chip technology was born: Microfluidics is characterized by the manipulation of fluids in micro- and nanoscale spaces and has the ability to shrink the basic functions of biology, chemistry and other laboratories, such as sample preparation, reaction, separation and detection, into a chip of several square centimeters. Its basic feature and greatest advantage lie in the flexible combination and large-scale integration of a plurality of unit technologies on an overall controllable micro-platform, which involves the intersection of disciplines in engineering, physics, chemistry, micro-processing and bioengineering.

At present, there are almost no POCT products using PCR technology at home and abroad. The current POCT products basically use chromatographic immunoassay in terms of technical route. The RGB color displayed after the reaction is read to identify the information. It is mainly used to detect cardiovascular, cerebrovascular and heart disease and provide rapid diagnosis. However, this type of technical solution is relatively mature and old. It only relies on qualitative judgment and cannot be accurately quantified. It often requires further quantitative testing to achieve precise treatment effects. However, the real-time fluorescent quantitative PCR detection technology solution can not only identify all molecular components, but also accurately detect their content, which is an accurate detection method that cannot be achieved by immunological methods. At present, the most representative one is the GeneXpert system of Cepheid Biotechnology of the United States. However, this system chip does not have the function of nucleic acid extraction, and the auxiliary equipment is large and the cost is high. In addition, all diagnostic reagents currently on the market have temperature requirements when performing cyclic amplification reactions. When the cyclic amplification reaction requires a plurality of (such as two or more) temperatures for reaction, the requirements for operating equipment are relatively high, especially for temperature control, and the operation is complex and costly.

### SUMMARY OF THE INVENTION

In view of this, the present invention aims to provide a POCT microfluidic chip. The POCT microfluidic chip is designed to comprise at least two constant temperature chambers, and the temperature between each constant temperature chamber is different. The constant temperature chambers communicate with each other through microchannels, so that a reaction liquid obtains the temperature required for the reagent reaction in each thermostatic constant temperature chamber, and reacts, and finally various information after the reaction is obtained. In addition to realizing all the functions of current QPCR, this POCT microfluidic chip also has the advantages of simple operation, lightweight and compact, low cost, fast detection, and can be operated by all personnel anytime and anywhere.

In order to achieve the above objects, the present invention provides the following technical solutions:

The invention provides a POCT microfluidic chip, comprising an upper casing and a lower casing, and further comprising:
a sample pool for collecting a sample to be tested and lysing the sample to be tested;
a mixed liquid pool, which is connected to the sample pool through a microchannel for extracting target fragments from the lysed sample to be tested;
a waste liquid pool, which is connected to the mixed liquid pool for collecting waste liquid produced during the extraction process of the target fragments; and
a reaction pool, which is connected to the mixed liquid pool through a microchannel, wherein the reaction pool comprises at least two independent constant temperature chambers, wherein a bottom of the constant temperature chambers is embedded with a superconducting thermal body and each constant temperature chamber has a different temperature, wherein the constant temperature chambers communicate with each other through microchannels, wherein each constant temperature chamber is equipped with an airbag pool, which communicates with a corresponding constant temperature chamber through a microchannel;
wherein the sample pool, the mixed liquid pool, the waste liquid pool and the reaction pool are all disposed on the lower casing, and on the upper casing a number of sample inlets are provided, which correspond to the sample pool, the mixed liquid pool and the reaction pool, respectively.

In a further embodiment, the material of the superconducting thermal body is selected from metal, single crystal silicon or ceramics.

In a further embodiment, the sample pool is provided with a lysis absorbing and releasing piece, for absorbing and releasing the sample to be tested and the lysis buffer to fully contact and lyse the same.

In a further embodiment, the sample inlet of the sample pool is sealed with an antifouling part.

In a further embodiment, a soft insert is provided on a surface of the upper casing, and the soft insert is used to cut off the connection between the reaction pool, the mixed liquid pool and the external environment.

In a further embodiment, the material of the soft insert is selected from TPE, TPR, PU or silicone combination.

In a further embodiment, the airbag pool comprises a pool body and a pressure airbag, wherein the pool body is disposed in the lower casing, wherein the pressure airbag is embedded in the upper casing and corresponds to the pool body, wherein by pressing the pressure airbag, a liquid in a corresponding constant temperature chamber is driven to flow.

The present invention further provides a POCT detection system, comprising a POCT detection equipment and the POCT microfluidic chip as mentioned above.

The present invention further provides a POCT detection method based on the POCT microfluidic chip as mentioned above, characterized by comprising the following steps:
adding a sample to be tested and lysis buffer to the sample pool to lyse the sample to be tested;
guiding a lysed sample mixture to be tested into a mixed liquid pool, and extracting target fragments from the sample to be tested with magnetic bead method;
guiding the extracted target fragments into the reaction pool, and at the same time, adding diagnostic reagents to the reaction pool, and the sample mixture to be tested entering each constant temperature chamber to perform cyclic reactions at various stages according to a temperature required for the reaction and driven by the respective airbag pools;
collecting a reaction signal of the constant temperature chamber of the final reaction in the reaction pool, performing calculation analysis and outputting a result.

The present invention further provides an application of the POCT microfluidic chip as mentioned above in nucleic acid detection.

Compared with the prior art, the beneficial effects of the present invention are as follows:

The POCT microfluidic chip in the present invention has a simple structure and low cost. It can greatly simplify the design of temperature control of auxiliary equipment and is low in cost, thereby greatly reducing the temperature control cost required for cyclic amplification reactions and is suitable for promotion.

### SUMMARY OF THE INVENTION

### Technical Problem

N/A

### Problem Solution

N/A

### Beneficial Effects of Disclosure

N/A

### BRIEF DESCRIPTION OF THE DRAWINGS

### Description of the Drawings

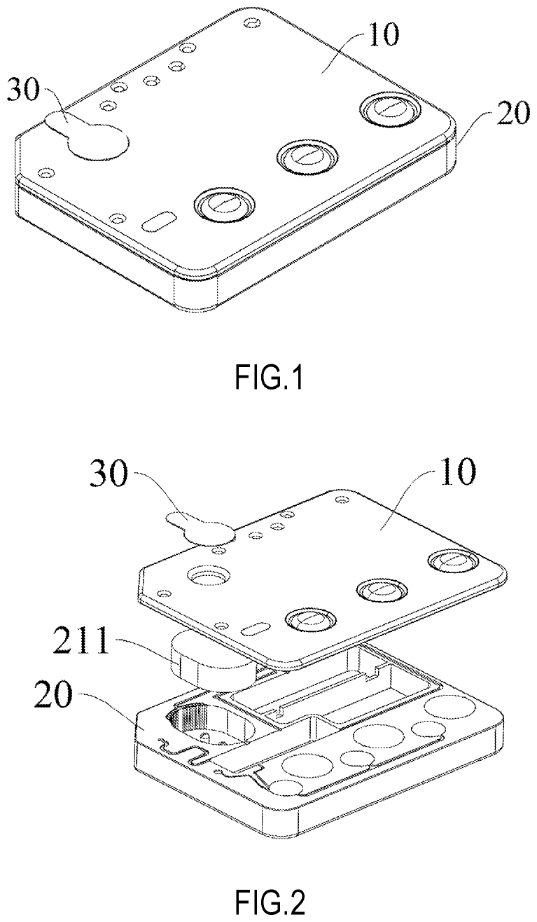

FIG. 1 is a schematic structural diagram of a POCT microfluidic chip in a preferred embodiment of the present invention;

FIG. 2 is a schematic exploded structural diagram of the POCT microfluidic chip in FIG. 1;

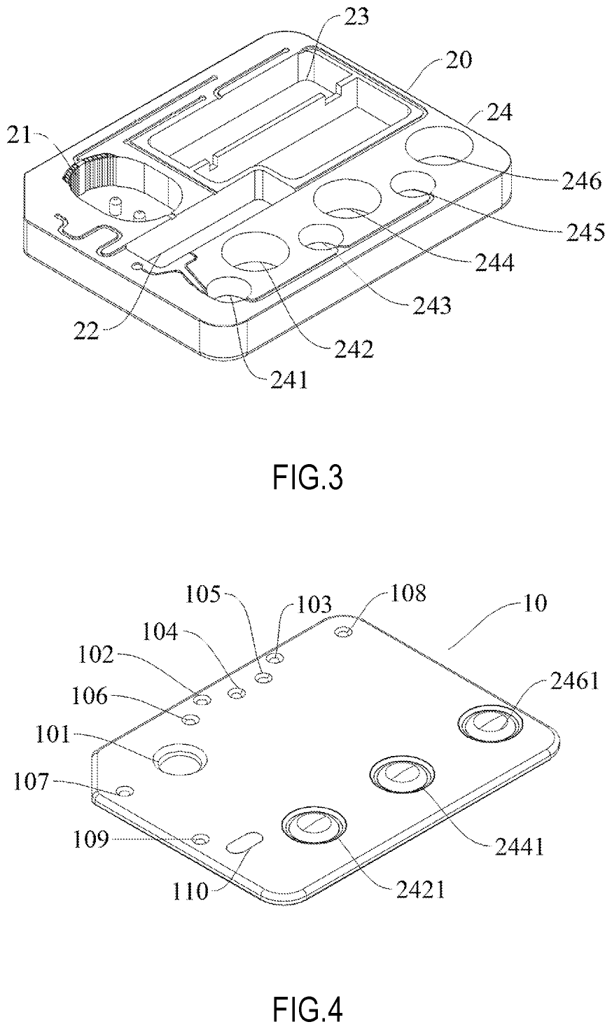

FIG. 3 is a schematic structural diagram of the lower casing 20 in FIG. 2;

FIG. 4 is a schematic structural diagram of the upper casing 10 in FIG. 2.

In the drawings: 10-upper casing, 101-sample inlet, 102-lysis buffer inlet, 103-pressure hole, 104-detergent inlet, 105-eluent inlet, 106-magnetic bead inlet, 107-pressure exhaust hole, 108-exhaust hole, 109-diagnostic reagent inlet, 110-soft insert;
20-lower casing, 21-sample pool, 211-lysis absorbing and releasing cotton, 22-mixed liquid pool, 23-waste liquid pool, 24-reaction pool, 241-first constant temperature chamber, 242-first airbag pool, 2421-first pressure airbag, 243-second constant temperature chamber, 244-second airbag pool, 2441-second pressure airbag, 245-third constant temperature chamber, 246-third airbag pool, 2461-third pressure airbag;
30-antifouling sticker.

### DETAILED DESCRIPTION OF THE EMBODIMENTS

The POCT microfluidic chip in the present invention will be described in further detail below with reference to the accompanying drawings.

It should be noted that when an element is referred to as being “fixed on”, “disposed on” or “mounted on” another element, it can be directly on the other element or indirectly on the other element. However, if an element is referred to as being “connected to” or “connected with” another element, it may be directly connected to the other element or indirectly connected to the other element. In addition, connection generally refers to the function of fixation, and the fixation here can be any conventional fixation method in this field, such as “threaded connection”, “riveting”, “welding”, etc.

It should be understood that terms indicating orientation or positional relationships such as “length”, “width”, “upper”, “lower”, “front”, “back”, “left”, “right”, “vertical”, “Horizontal”, “top”, “bottom”, “inside”, “outside”, etc. are based on the orientation or positional relationship shown in the accompanying drawings of the specification. This is only to facilitate the description of the embodiments of the present invention and to simplify the description, but does not indicate or imply that the device or element referred to must have a specific orientation, be constructed or operated in a specific orientation, and therefore cannot be construed as a limitation of the present invention.

Referring to FIGS. 1 and 2, a POCT microfluidic chip is shown, which comprises an upper casing 10 and a lower casing 20. The upper casing 10 and the lower casing 20 are bonded by conventional bonding methods in the art to form a whole chip. Specific bonding processes comprise but are not limited to electrostatic bonding, thermocompression bonding or laser bonding, and are not particularly limited. Here, the materials of the upper casing 10 and the lower casing 20 can be conventional choices in the art, such as highly transparent plastics, metal alloys, non-metals or other mixed materials. It should be noted that in order to achieve the purpose of fluorescence detection, the upper casing 10 must be made of a highly transparent material, while the lower casing 20 is not particularly limited, and any material that meets the biocompatibility of the material can be used for the lower casing 20. Further, with reference to FIG. 3, in this embodiment, on the lower casing 20 a sample pool 21, a mixed liquid pool 22, a waste liquid pool 23 and a reaction pool 24 are provided. The specific positions can be adjusted according to actual needs and are not particularly limited. The reaction pool 24 comprises at least two independent constant temperature chambers. The number of constant temperature chambers can be adjusted according to the temperature stages required for the actual reaction, and can be 2, 3, 4, etc. For example, conventional cyclic amplification reactions in this field generally require two or three reactions at different temperatures. In this case, two or three constant temperature chambers can be provided. As shown in FIG. 3, in the POCT microfluidic chip structure of this embodiment, the reaction pool 24 comprises a first constant temperature chamber 241, a second constant temperature chamber 243 and a third constant temperature chamber 245, and the temperatures of the three constant temperature chambers are different, thereby achieving the temperature control required in different reaction stages. Furthermore, each constant temperature chamber is equipped with a corresponding airbag pool, which are a first airbag pool 242, a second airbag pool 244 and a third airbag pool 246, respectively, as shown in FIG. 3. Each airbag pool communicates with a corresponding constant temperature chamber through a microchannel, and the constant temperature chambers communicate with each other through microchannels, so that the flow of liquid between each constant temperature chamber can be controlled through the airbag pools. In addition, with reference to FIG. 4, there are a plurality of sample inlets in the upper casing 10, corresponding to the sample pool 21, the mixed liquid pool 22, the waste liquid pool 23 and the reaction pool 24, respectively. The specific number and position of the sample inlets can be adjusted according to the specific location and needs.

Continuing to refer to FIGS. 2 and 3, specifically, the sample pool 21 is used to collect the sample to be tested and lyse the sample to be tested. As shown in FIGS. 2 and 3, a lysis absorbing and releasing cotton 211 is provided in the sample pool 21. The lysis absorbing and releasing cotton 211 has a hydrophilic effect and is used to absorb the sample to be tested and the lysis buffer, so that the sample to be tested is fully contacted with the lysis buffer and lysed. Preferably, the lysis absorbing and releasing cotton 211 can also have a lysis effect, thereby allowing the sample to be tested to be more fully lysed. The fixing method of the lysis absorbing and releasing cotton 211 is not particularly limited. Specifically, in this embodiment as shown in FIG. 3, a stud is provided in the sample pool 21, and the lysis absorbing and releasing cotton 211 is inserted onto the stud to realize fixation. Further, with reference to FIG. 4, a sample inlet 101 and a lysis buffer inlet 102 are provided in the upper casing 10 corresponding to the position of the sample pool 21. The sample to be tested and the lysis buffer can be added to the sample pool 21 through the sample inlet 101 and the lysis buffer inlet 102, respectively, to obtain a lysed sample mixture. By adding the sample to be tested and the lysis buffer into the sample pool 21 through different inlets, the inlet for adding the lysis buffer of the supporting equipment can be prevented from being contaminated by the sample to be tested. In addition, in this embodiment, the lysis buffer inlet 102 is connected to the sample pool 21 through a plurality of microchannels, so that the sample can be more fully lysed. As shown in FIG. 4, in the upper casing 10, a pressure hole 103 is also provided for applying pressure through an external pressurizing device, for driving the lysis buffer into the sample pool 21 through pressure.

Further, as shown in FIGS. 1 and 2, the sample inlet 101 is sealed with an antifouling sticker 30. The antifouling sticker 30 seals the sample inlet 101. On the one hand, the lysis absorbing and releasing cotton 211 fixed in the sample pool 21 is prevented from being contaminated by the outside. On the other hand, the sample inlet 101 can be sealed again after the sampling is completed to avoid interference from the external environment, thereby ensuring the accuracy of the reaction. It should be noted that the sticky side of the antifouling sticker 30 must not react with the sample to be tested.

Further, still referring to FIG. 3, in this embodiment, the mixed liquid pool 22 is connected to the sample pool 21 through a microchannel. The mixed liquid pool 22 is used to further lyse the mixture of sample to be tested, and extract target fragments from the lysed sample mixture to be tested. The lysed sample mixture to be tested in the sample pool 21 is continuously lysed while entering the mixed liquid pool 22 through the microchannel to ensure adequacy of lysis. In this embodiment, the magnetic bead method is used to extract target fragments from the sample to be tested in the mixed liquid pool 22. Referring to FIG. 4, at the position of the upper casing 10 corresponding to the mixed liquid pool 22 a detergent inlet 104, an eluent inlet 105, a magnetic bead liquid inlet 106 and a pressure exhaust hole 107 are provided. Through the detergent inlet 104, the eluent inlet 105 and the magnetic bead liquid inlet 106, the required detergent, eluent and magnetic bead liquid are added to the mixed liquid pool 22, while the pressure exhaust hole 107 is used to pressurize the mixed liquid pool 22 to drive the flow of fluid through pressure.

Further, still referring to FIG. 3, the waste liquid pool 23 and the mixed liquid pool 22 are connected through a microchannel. The number of connected microchannels is not particularly limited. The waste liquid pool 23 is used to collect the waste liquid produced during the extraction process of the target fragments in the mixed liquid pool 22. Specifically, with reference to FIG. 4, an exhaust hole 108 is provided on the upper casing 10 corresponding to the position of the waste liquid pool 23, and is used to discharge the gas, which is formed in the process of guiding the waste liquid, which is produced by the chip during the reaction, to the waste liquid pool.

Further, as shown in FIG. 3, in this embodiment, the reaction pool 24 comprises a first constant temperature chamber 241, a second constant temperature chamber 243 and a third constant temperature chamber 245. The first constant temperature chamber 241 communicates with the mixed liquid pool 22 through a microchannel. On the upper casing 10 a diagnostic reagent inlet 109 is provided, which is connected to the first constant temperature chamber 241 through a microchannel. Diagnostic reagents are added into the first constant temperature chamber 241 through the diagnostic reagent inlet 109 to perform a first temperature stage cyclic amplification reaction with the target fragments. A bottom of each constant temperature chamber is embedded with a superconducting thermal body (not shown in the figure). Specifically, the lower casing 20 is provided with a recess, and a superconducting thermal body is embedded at the bottom of the recess. By bonding the upper casing 10 and the lower casing 20, the superconducting thermal body forms an independent constant temperature chamber with the upper casing 10 and the lower casing 20, respectively. Here, the superconducting thermal body is made of a superconducting thermal material, which has a thermal conductivity of >200 W/m·° C. and is inert to the reactants in each constant temperature chamber. The inertness means that the material does not react with the reactants in each constant temperature chamber. Specifically, this can be achieved by performing inert oxidation treatment on the surface of the material. The superconducting thermal material can be selected from metal, single crystal silicon or ceramics. Further, the constant temperature chambers communicate with each other through microchannels, and each constant temperature chamber is equipped with an airbag pool. As shown in FIG. 3, the first airbag pool 242, the second airbag pool 244 and the third airbag pool 246 are respectively provided on the lower casing 20. Referring to FIG. 4, the upper casing 10 is provided with a first pressure airbag 2421, a second pressure airbag 2441 and a third pressure airbag 2461 corresponding to the first airbag pool 242, the second airbag pool 244 and the third airbag pool 246, respectively. The first pressure airbag 2421, the second pressure airbag 2441 and the third pressure airbag 2461 are made of elastic soft material, such as rubber. By pressing the airbag, the pressure in the corresponding airbag pool is changed, thereby driving the flow of liquid in the corresponding constant temperature chamber.

Further, referring to FIG. 4, a soft insert 110 is also provided on the upper casing 10. The soft insert 110 corresponds to the diagnostic reagent inlet 109 and the microchannel connecting the mixed liquid pool 22 and the first constant temperature chamber 241. Specifically, on the upper casing 10 a hole for receiving the soft insert 110 is provided, so that the soft insert 110 is embedded in the upper casing 10. Through the cooperation of external supporting equipment, pressure is exerted on the soft insert 110 so that the soft insert 110 is pressed down, thus cutting off the connection between the first constant temperature chamber 241 and the outside and the mixed liquid pool 22. This avoids aerosol contamination generated during the reaction. In this embodiment, the soft insert 110 is made of soft plastic or colloid. Specific examples comprise but are not limited to combinations of TPE, TPR, PU or silicone combination. The reaction pool 24 can be sealed well by using these soft materials.

The specific workflow of the POCT microfluidic chip described in this embodiment is:
dropping the original sample solution to be tested from the sample inlet 101 onto the lysis absorbing and releasing cotton 211 of the sample pool 21, then inserting the POCT microfluidic chip into the supporting equipment, setting the operating program and starting the operation; the supporting equipment first pressing the sample to be tested and the lysis buffer into the lysis absorbing and releasing cotton 211 through the sample inlet 101 and the lysis buffer inlet 102 to lyse the sample to be tested; the lysed sample mixture flowing into the mixed liquid pool 22 through the microchannel; the sample to be tested being continuously lysed during the process of entering the mixed liquid pool 22;
opening the magnetic bead liquid inlet 106 to add the magnetic bead liquid into the mixed liquid pool 22 when the sample mixture has just flowed into the mixed liquid pool 22; the supporting equipment providing vibration and heating functions after specified amounts of the two liquids are added, to promote the full reaction between the lysis buffer and the sample to be tested, so that the DNA fragments are fully released and combined with the magnetic beads; energizing the electromagnetic strip of the auxiliary supporting equipment after this process is completed, and attracting the magnetic beads in the mixed liquid pool 22 around the electromagnetic strip; pressurizing the pressure exhaust hole 107 above the mixed liquid pool 22 at this time (the first airbag pool 242, the second airbag pool 244 and the third airbag pool 246 are in the pressed state of the pressure airbags at this time), discharging the waste liquid into the waste liquid pool 23 through the microchannel under drive pressure; adding a predetermined amount of eluent into the mixed liquid pool 22 from the eluent inlet 105 after the waste liquid is drained; turning off the electromagnetic strip at this time, and the supporting equipment providing vibration to promote the separation of DNA fragments and magnetic beads; then turning on the electromagnetic strip again to attract the magnetic beads; the pressure exhaust hole 107 above the mixed liquid pool 22 working again, and releasing the pressure airbag of the first airbag pool 242 (the pressure airbags of the second airbag pool 244 and the third airbag pool 246 are in the pressed state at this time), and adding the DNA sample liquid in the mixed liquid pool 22 to the first constant temperature chamber 241 in the lower casing 20 for reaction; the auxiliary equipment pressing the pressure airbag of the first airbag pool 242 and releasing the pressure airbag of the second airbag pool 244 at the same time after the reaction is completed to force the reaction liquid to enter the second constant temperature chamber 243; the reaction liquid obtaining the temperature required for the reaction in the second constant temperature chamber 243 and performing the second stage reaction; the auxiliary device pressing the pressure airbag of the second airbag pool 244 after a prescribed time and releasing the third airbag pool 246 at the same time to force the reaction liquid into the third constant temperature chamber 245; the reaction liquid obtaining the temperature required for the reaction in the third constant temperature chamber 245 and performing the third stage reaction; a photoelectric sensor probe collecting the signal after the third reaction after a specified time and transmitting it to a software system for calculation and storage; following the same steps to prompt the reaction liquid to flow and react between the three different constant temperature chambers, and collecting the signals after each reaction in the third reaction chamber and transmitting the same the software system for calculation, and displaying the final results to customer. It can be understood that the supporting equipment described in this process is an automated instrument, which can be programmed to cooperate with the fluorescence detection chip to complete the entire detection process, which will not be described in detail here. Since each constant temperature chamber in this embodiment is an independent reaction chamber, the auxiliary equipment only needs to maintain the temperature of each constant temperature chamber through simple circuit design. The reaction can be completed by driving the reactants to be measured into the constant temperature chamber at the required temperature through the supporting airbag pool. Compared with traditional temperature control methods, this POCT microfluidic chip greatly reduces costs, is more portable, and is easy to operate.

This embodiment further provides a POCT detection system, which at least comprises a POCT detection equipment and the above-mentioned POCT microfluidic chip, and may also comprise some automated operating equipment, control and result analysis modules, etc. The POCT detection equipment can be used in conjunction with the POCT microfluidic chip. Specific examples that can be mentioned comprise but are not limited to some conventional detectors or detecting device. The result analysis module comprises but is not limited to computers and supporting operation and analysis software.

Based on the POCT microfluidic chip provided in this embodiment, the present invention further discloses a POCT detection method, comprising the following steps:
adding a sample to be tested and lysis buffer to the sample pool to lyse the sample to be tested;
guiding a lysed sample mixture to be tested into a mixed liquid pool, and extracting target fragments from the sample to be tested with magnetic bead method;
guiding the extracted target fragments into the reaction pool, adding diagnostic reagents into the reaction pool at the same time, and controlling liquid flow in different constant temperature chambers through the airbag pools to perform various stages of reactions;
collecting a reaction signal in the constant temperature chamber of the final reaction and transmitting the same to the analysis system, and outputting results after calculation and analysis.

In addition, as an alternative, the POCT microfluidic chip in the present invention, in addition to the chip structure formed by the upper casing 10 and the lower casing 20, can also be provided with a multi-layer stacked structure (such as 3 layers, 4 layers, etc.) comprising at least one layer of casing on the upper casing 10 and the lower casing 20. By setting up a multi-layer superposition structure, each microchannel or reaction chamber can be arranged in layers, thereby rationally optimizing the internal structure of the chip. As a result, the microchannels do not interfere with each other and can communicate with each other when needed. The specific structure can be adjusted according to actual conditions. Specifically, a number of through holes can be provided on in an intermediate casing, and the microchannel of each reaction chamber can be reasonably distributed through these through holes to avoid mutual interference of the microchannels.

Furthermore, the POCT microfluidic chip in the present invention can also detect a plurality of samples at the same time or a plurality of people for the same item. The details can be adjusted according to actual needs and chip size, which will not be elaborated here. Specifically, the lower casing 20 can be provided with two sample pools 21, two mixed liquid pools 22, and reaction pools 24 (the sample pools 21, the mixed liquid pools 22, and the reaction pools 24 are in a one-to-one correspondence), and one of the mixed liquid pools 22 is connected to the reaction pool 24 through a microchannel. The other one of the mixed liquid pools 22 is connected to another reaction pool 24 through a microchannel, thereby realizing the detection of a plurality of samples for one person, or the detection of a plurality of people for the same item.

The technical features of the above-described embodiments can be combined in any way. In order to make the description concise, not all possible combinations of each technical feature in the above embodiments are described. However, as long as there is no contradiction in the combination of these technical features, it should be considered to be within the scope of this specification.

The above-mentioned embodiments only express several implementations of the present invention, and their descriptions are relatively specific and detailed, but they should not be construed as limiting the scope of the invention. It should be noted that, for those of ordinary skill in the art, several modifications and improvements can be made without departing from the concept of the present invention, and these all belong to the protection scope of the present invention. Therefore, the scope of protection of the present patent invention should be determined by the appended claims.

1. A POCT microfluidic chip, comprising an upper casing and a lower casing, further comprising:
a sample pool, for collecting a sample to be tested and lysing the sample to be tested;
a mixed liquid pool, which is connected to the sample pool through a microchannel for extracting target fragments from a lysed sample to be tested;
a waste liquid pool, which is connected to the mixed liquid pool for collecting waste liquid produced during an extraction process of the target fragments; and
a reaction pool, the reaction pool is connected to the mixed liquid pool through a microchannel, wherein, the reaction pool comprises at least two constant temperature chambers, a bottom of each of the constant temperature chambers is embedded with a superconducting thermal body and each of the constant temperature chambers has a different temperature, the constant temperature chambers communicate with each other through microchannels; each of the constant temperature chambers is equipped with an airbag pool, the airbag pool communicates with a corresponding constant temperature chamber through a microchannel;
wherein, the sample pool, the mixed liquid pool, the waste liquid pool and the reaction pool are all disposed on the lower casing, and on the upper casing a number of sample inlets are provided, which correspond to the sample pool, the mixed liquid pool and the reaction pool, respectively;
wherein a soft insert is provided on a surface of the upper casing, and the soft insert is used to cut off the connection between the reaction pool, the mixed liquid pool and the external environment;
wherein the airbag pool comprises a pool body and a pressure airbag, wherein the pool body is located in the lower casing, wherein the pressure airbag is embedded in the upper casing and corresponds to the pool body, wherein by pressing the pressure airbag, a liquid in a corresponding constant temperature chamber is driven to flow.

2. The POCT microfluidic chip according to claim 1, wherein a material of the superconducting thermal body is selected from metal, single crystal silicon or ceramics.

3. The POCT microfluidic chip according to claim 1, wherein the sample pool is provided with a lysis absorbing and releasing piece for absorbing and releasing the sample to be tested and a lysis buffer to fully contact and lyse the same.

4. The POCT microfluidic chip according to claim 1, wherein the sample inlet of the sample pool is sealed with an antifouling part.

5. (canceled)

6. The POCT microfluidic chip according to claim 1, wherein a material of the soft insert is selected from TPE, TPR, PU or silicone combination.

7. (canceled)

8. A POCT detection system, comprising a POCT detection equipment, further comprising the POCT microfluidic chip according to claim 1.

9. The POCT microfluidic chip according to claim 1, wherein the POCT microfluidic chip runs the following POCT detection method:
adding the sample to be tested and a lysis buffer to the sample pool to lyse the sample to be tested;
guiding the lysed sample mixture to be tested into the mixed liquid pool, and extracting the target fragments from the sample to be tested with magnetic bead method;
guiding an extracted target fragments into the reaction pool, and at the same time, adding diagnostic reagents to the reaction pool, and the sample mixture to be tested entering each of the constant temperature chambers to perform cyclic reactions at various stages according to a temperature required for a reaction and driven by respective airbag pools; and
collecting a reaction signal of the constant temperature chamber of a final reaction in the reaction pool, performing calculation analysis and outputting a result.

10. (canceled)
